(19) United States
(12) Patent Application Publication
(10) Pub. No.: US 2011/0168666 A1
(43) Pub. Date: Jul. 14, 2011

(54) MANUFACTURING METHOD FOR OPTICAL WAVEGUIDE

(75) Inventors: Joon-Sung KIM, Suwon-si (KR); Han-Seo Cho, Daejeon (KR); Jae-Hyun Jung, Ansan-si (KR); Jong-Ha Park, Suwon-si (KR); Sang-Hoon Kim, Goonpo-si (KR)

(73) Assignee: SAMSUNG ELECTRO-MECHANICS CO., LTD.

(21) Appl. No.: 12/986,767

(22) Filed: Jan. 7, 2011

(30) Foreign Application Priority Data
Jan. 8, 2010 (KR) 10-2010-0001906

(51) Int. Cl. H01P 11/00; B32B 37/02; B32B 37/14; B32B 38/10

(52) U.S. Cl. 216/13; 156/247

(57) ABSTRACT

A method of manufacturing an optical waveguide is disclosed. The method in accordance with an embodiment of the present invention includes providing a carrier, fixing a base substrate to the carrier by using a first insulation layer such that the base substrate is directly stacked on the carrier, stacking an optical waveguide layer on at least one of the base substrate and the first insulation layer, and severing the base substrate such that the base substrate and the optical waveguide layer are separated from the carrier. Accordingly, the optical waveguide layer can be formed with a uniform thickness since wrinkles in the base substrate supporting the optical waveguide layer are prevented from forming during the manufacturing process.

### CROSS-REFERENCE TO RELATED APPLICATIONS

This application claims the benefit of Korean Patent Application No. 10-2010-0001906, filed with the Korean Intellectual Property Office on Jan. 8, 2010, the disclosure of which is incorporated herein by reference in its entirety.

### BACKGROUND

1. Technical Field

The present invention is related to a method for manufacturing an optical waveguide.

2. Description of the Related Art

Due to the high speed and large capacity of data processed in electronic components, the conventional printed circuit board technology using copper-based electrical wiring patterns has reached its limit. In order to overcome the problems of the copper-based electrical wiring patterns, optical wiring is recently receiving attention.

The optical wiring, which can transmit and receive signals through light, is made of polymers having a high optical transmittance and includes an optical waveguide that is constituted by a core unit, which has a rectangular cross-section with the thickness of about 50 um and in which signals are actually propagated, and a clad layer, which surrounds the core unit.

The core layer and the clad layer of the optical waveguide are sometimes formed by coating a core substance and a clad substance on a flexible copper clad laminate (FCCL). However, the flexible copper clad laminate is sometimes wrinkled during the manufacturing process. This cause a deviation in height of the flexible copper clad laminate, causing defect when the core substrate and the clad substance are coated.

Furthermore, in the conventional technology, the core unit is formed by patterning a core layer after the core layer is formed by coating a core substance on the front surface of a substrate, thus wasting the expensive core substrate.

### SUMMARY

The present invention provides a method of manufacturing an optical waveguide that can prevent a wrinkle in a base substrate that supports an optical waveguide layer during the manufacturing process of the optical waveguide.

The present invention also provides an optical wiring board and a method of manufacturing the optical wiring board that can minimize unnecessary waste of core substance.

An aspect of the present invention provides a method of manufacturing an optical waveguide. The method in accordance with an embodiment of the present invention can include providing a carrier, fixing a base substrate to the carrier by using a first insulation layer such that the base substrate is directly stacked on the carrier, stacking an optical waveguide layer on at least one of the base substrate and the first insulation layer, and severing the base substrate such that the base substrate and the optical waveguide layer are separated from the carrier.

The fixing of the base substrate can include stacking the base substrate on the carrier and stacking the first insulation layer on the carrier such that the base substrate is fixed to the carrier.

The fixing of the base substrate can include adhering the first insulation layer to one surface of the base substrate and stacking the base substrate and the first insulation layer on the carrier in such a way that the other surface of the base substrate faces the carrier and then coupling the first insulation layer to the carrier.

The stacking of the first insulation layer can include stacking the first insulation layer on the carrier such that a wiring groove housing the optical waveguide layer is formed.

The stacking of the first insulation can include providing a first insulation layer having a first through-hole formed therein, in which the first through-hole corresponds to the wiring groove, and stacking the first insulation layer on the carrier such that the first insulation layer covers a perimeter of the base substrate.

The stacking of the first insulation layer can include stacking a first insulation layer on the carrier, in which the first insulation layer covers the base substrate, and forming the wiring groove by selectively removing the first insulation layer.

The stacking of the optical waveguide layer can include forming a first clad layer by filling a first clad substance in the wiring groove, stacking a second insulation layer having a second through-hole formed therein on the base substrate or the first insulation layer, in which the second through-hole corresponds to the wiring groove, forming a core unit on the first clad layer, and forming a second clad layer by filling a second clad substance in the second through-hole, in which the second clad layer covers the core unit.

The forming of the first clad layer can include filling a first clad substance in the wiring groove, flattening the filled first clad substance, and hardening the filled first clad substance.

The forming of the core unit can include filling a core substance in the second through-hole, flattening the filled core substance, and hardening the filled core sub stance.

The forming of the core unit can further include patterning the hardened core substance by using a laser.

The forming of the second clad layer can include filling a second clad substance in the second through-hole and hardening the filled second clad substance.

The base substrate can include a flexible copper clad laminate (FCCL), and in the fixing of the base substrate, the flexible copper clad laminate can be stacked on the carrier in such a way that a copper thin layer faces the carrier.

The method can further include, after the severing of the base substrate, forming a circuit pattern by selectively etching the copper thin layer of the flexible copper clad laminate.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a flow diagram illustrating a method of manufacturing an optical waveguide in accordance with an embodiment of the present invention.

FIGS. 2 to 12 are diagrams illustrating a method of manufacturing an optical waveguide in accordance with an embodiment of the present invention.

### DETAILED DESCRIPTION

The features and advantages of this invention will become apparent through the below drawings and description.

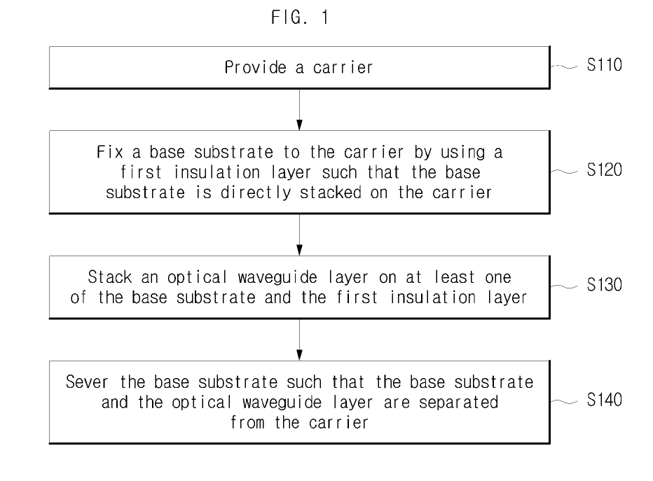

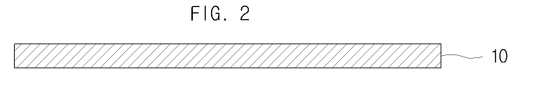

FIG. 1 is a flow diagram illustrating a method of manufacturing an optical waveguide in accordance with an embodiment of the present invention, and FIGS. 2 to 12 are diagrams illustrating a method of manufacturing an optical waveguide in accordance with an embodiment of the present invention.

The method of manufacturing an optical waveguide in accordance with an embodiment of the present invention includes providing a carrier (S110), fixing a base substrate (S120), stacking an optical waveguide layer (S130) and severing the base substrate (S140).

In the step of providing a carrier (S110), a carrier 10 is provided. The carrier 10 supports a base substrate 20 and an optical waveguide layer 40, which will be described later in association with the manufacturing process of an optical waveguide. Here, the carrier 10 is made of a very hard material in order to prevent the supported base substrate 20 from being wrinkled. Specifically, a synthetic resin substrate including, for example, a metal substrate, a copper clad laminate (CCL) and epoxy can be used as the carrier 10.

In the step of fixing a base substrate (S120), the base substrate 20 is fixed to the carrier 10 by using a first insulation layer 30 such that the base substrate 20 is directly stacked on the carrier 10. For this, in the step of fixing a base substrate (S120) of the present embodiment, the base substrate 20 and the first insulation layer 30 can be successively staked.

First, the base substrate 20 is stacked and seated on the carrier 10. If the base substrate 20 is formed to be thin or curved according to the purposes, the base substrate 20 may be wrinkled during the stacking process of the optical waveguide layer 40 since the base substrate 20 is flexible. To prevent this, the base substrate 20 is stacked on and supported by the carrier 10 having a high hardness.

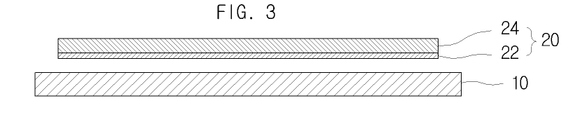

In the present embodiment, as illustrated in FIG. 3, a flexible copper clad laminate (FCCL) that is constituted by a copper thin layer 22 and a polyimide layer 24 can be used as the base substrate 20. In the present embodiment, the flexible copper clad laminate is made smaller than the carrier 10 so that the entire surface of the flexible copper clad laminate can be securely seated on the carrier 10. Moreover, since the smooth copper layer 22 is stacked to face the carrier 10, the base substrate 20 can be easily separated from the carrier 10 after the optical waveguide layer 40 is stacked.

Next, the first insulation layer 30 is stacked on the carrier 10 such that the base substrate 20 is fixed to the carrier 10. The first insulation layer 30 fixes the base substrate 20 to the carrier 10 by being coupled to the carrier 10 and the base substrate 20, which is stacked on the carrier 10. Here, an insulator, for example, a coverlay stacked on the base substrate 20, can be used as the first insulation layer 30. The first insulation layer 30 can be stacked on the carrier 10 by way of, for example, vacuum laminating or V-pressing in such a way that the first insulation layer 30 is coupled to the carrier 10 and the base substrate 20.

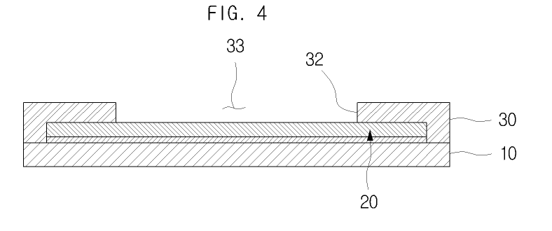

In the present embodiment, as illustrated in FIG. 4, the base substrate 20 is fixed to the carrier 10 by the first insulation layer 30, which is stacked on the carrier 10 in such a way that the first insulation layer 30 covers the perimeter of the base substrate 20.

In the present embodiment, a wiring groove 33 in which the optical waveguide layer 40 is housed can be formed by the base substrate 20 and the first insulation layer 30. Specifically, after a first through-hole 32 corresponding to the wiring groove 33 is formed in the first insulation layer 30, the first insulation layer 30 can be stacked on the carrier 10 so as to cover the perimeter of the base substrate 20. Accordingly, as illustrated in FIG. 4, the wiring groove 33 surrounded by an inner wall of the first through-hole 32 and the base substrate 20 can be formed.

It is also possible that the wiring groove 33 is formed by selectively removing the first insulation layer 30 after the first insulation layer 30 covering the base substrate 20 is stacked on the carrier 10. Specifically, after a photosensitive coverlay is stacked on the carrier 10 in such a way the photosensitive coverlay covers the base substrate 20, the photosensitive coverlay can be selectively exposed and developed so that the wiring groove 33 is formed on the base substrate 20.

Meanwhile, in the step of fixing a base substrate (S120), it is also possible that the base substrate 20 is stacked on and fixed to the carrier 10 after the first insulation layer 30 is prefixed to the base substrate 20.

Specifically, the first insulation layer 30 is adhered to one surface of the base substrate 20, and then the base substrate 20 and the first insulation layer 30 are stacked on the carrier 10 in such a way that the other surface of the base substrate 20 faces the carrier 10. Then, the base substrate 20 can be fixed to the carrier 10 by coupling the first insulation layer 30, which is stacked on one surface of the base substrate 20, to the carrier 10.

In other words, the base substrate 20 can be fixed by coupling the remaining part of the first insulation layer 30 that is remained after covering the base substrate 20 (i.e., the part of the first insulation layer 30 that protrudes toward a side of the base substrate 20) to the carrier 10.

In the step of stacking an optical waveguide layer (S130), the optical waveguide layer 40 is stacked on at least one of the base substrate 20 and the first insulation layer 30. Specifically, the optical waveguide layer 40 can be directly stacked on the exposed base substrate 20, or the optical waveguide layer 40 can be stacked on the first insulation layer 30, which is stacked on the base substrate 20.

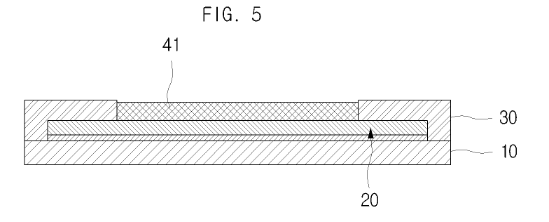

In the present embodiment, as illustrated in FIGS. 5 to 9, in order to form the optical waveguide layer 40, a first clad layer 41 is first stacked, and then a core unit 43 is formed on the first clad layer 41. Then, the core unit 43 is covered by a second clad layer 45. For this, the step of stacking an optical waveguide layer (S130) includes forming the first clad layer 41, stacking a second insulation layer 35, forming the core unit 43 and forming the second clad layer 45.

First, as illustrated in FIG. 5, a first clad substance is filled in the wiring groove 33 to form the first clad layer 41. Here, the thickness of the first clad layer 41 can be easily adjusted by adjusting the depth of the wiring groove 33 or the filling amount of the first clad substance. Particularly, since the first clad layer 41 is formed by filling the first clad substance in a groove structure, the first clad layer 41 having a desired thickness can be formed. Moreover, since the first clad substance is filled in the wiring groove 33 only, unnecessary waste of the first clad substance can be prevented during the forming process of the first clad layer 41.

Here, the first clad substance can be made of a material of polymer series including acryl, epoxy, polyimide, etc.

Furthermore, the first clad substance can be made of a liquid material, and the liquid-state first clad substance can be filled by various methods such as dispensing, ink jetting and printing.

Specifically, in the present embodiment, the first clad layer 41 is formed by first filling the first clad substance in the wiring groove 33 and then flattening and hardening the filled first clad substance. Since the first clad substance filled in the wiring groove 33 is evenly distributed with a uniform thickness by the flattening process, the first clad layer 41 can be formed with a uniform thickness.

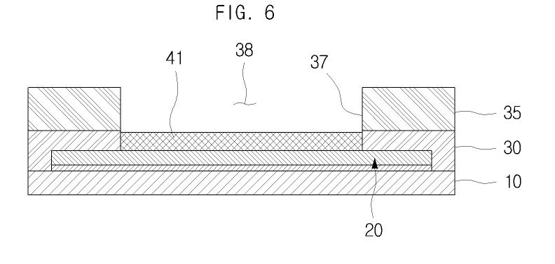

Next, as illustrated in FIG. 6, the second insulation layer 35, in which a second through-hole 37 corresponding to the wiring groove 33 is formed, is stacked on the base substrate 20. That is, the second through-hole 37, which is connected with the wiring groove 33, is disposed over the wiring groove 33.

With this arrangement, the second through-hole 37 of the second insulation layer 35 forms a space 38 in which the core unit 43 to be described later can be disposed. Accordingly, by filling a core substance 42 in the first through-hole 32 only, unnecessary waste of the core substance 42 can be prevented during the forming process of the core unit 43.

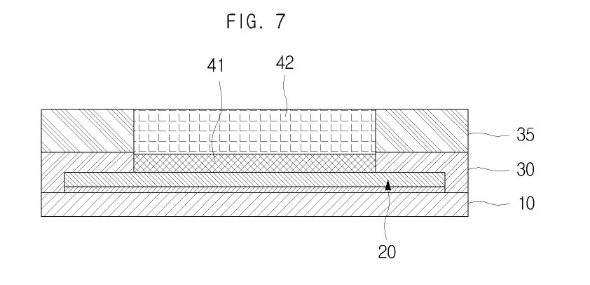

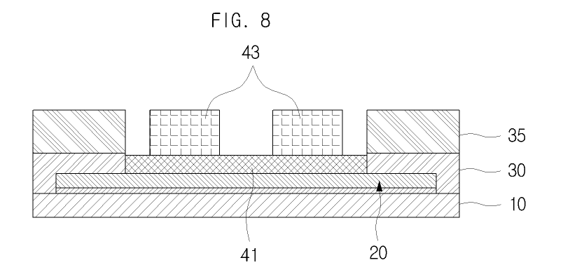

Next, as illustrated in FIGS. 7 and 8, the core unit 43 is formed on the first clad layer 41, which is exposed through the second through-hole 37. The core unit 43 is a path through which an optical signal is transferred and has a higher refractive index than the first clad layer 41 and the second clad layer 45, which will be described later, for efficient optical signal transmission.

In the present embodiment, the core unit 43 is formed by filling the core substance 42 in the second through-hole 37. Accordingly, by adjusting the thickness of the second insulation layer 35 or the filling amount of the core substance 42, the thickness of the core unit 43 can be readily adjusted. Particularly, since the core unit 43 is formed by filling the core substance 42 in a groove structure, the core unit 43 having a desired thickness can be formed.

Here, the core substance 42 is made of a material of polymer series that is similar to that of the first clad substance, and can be filled by the known methods described above.

In the present embodiment, after the core substance 42 is filled in the second through-hole 37, the filled core substance 42 can be flattened and hardened to form the core unit 43. Since the core substance 42 filled in the second through-hole 37 is evenly distributed with a uniform thickness by the flattening process, the core unit 43 can be formed with a uniform thickness.

Furthermore, the core substance 42 can be hardened by selectively exposing the core substance 42 to, for example, ultraviolet rays by using a mask in which a pattern corresponding to the shape of the core unit 43 is formed. Accordingly, by developing the exposed core substance 42, the core unit 43 having a desired shape can be formed.

Meanwhile, it is also possible to form the core unit 43 having a desired shape by selectively patterning the hardened core substance 42 by using a laser after the entire core substance 42 filled in the second through-hole 37 is hardened.

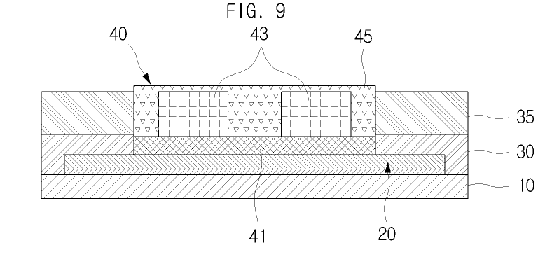

Next, as illustrated in FIG. 9, the second clad layer 45 covering the core unit 43 is formed by filling a second clad substance in the second through-hole 37.

Here, the second clad substance is made of a material of polymer series that is similar to that of the first clad substance, and can be filled by the known methods described above.

Specifically, in the present embodiment, the second clad layer 45 is formed by first filling the second clad substance in the second through-hole 37 and then flattening and hardening the filled second clad substance.

In the step of severing the base substrate (S140), the base substrate 20 is severed such that the base substrate 20 and the optical waveguide layer 40 are separated from the carrier 10. Specifically, a section of the base substrate 20 and a section of the first insulation layer 30 coupled to the base substrate 20 are severed to be separated from a part of the first insulation layer 30 that is coupled to the carrier 10.

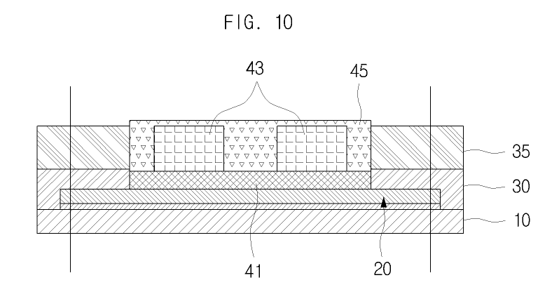

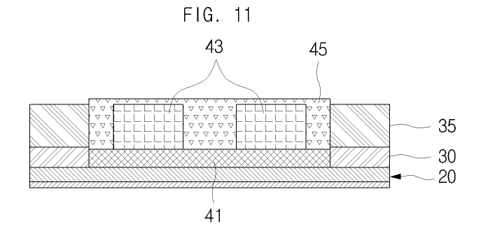

In the present invention, as illustrated in FIG. 10, the perimeter of the base substrate 20 is fixed to the carrier 10 by the first insulation layer 30. Accordingly, by severing the perimetric part of the base substrate 20 that is coupled to the first insulation layer 30, the base substrate 20 and the optical waveguide layer 40 can be separated from the carrier 10, as illustrated in FIG. 11. Here, the first insulation layer 30 and the second insulation layer 35 stacked on the base substrate 20 are severed together so that the second insulation layer 35 can remain to be stacked on the base substrate 20 when separated from the carrier 10.

Accordingly, in the step of stacking an optical waveguide layer (S130), the base substrate 20 can be securely supported to the carrier 10 by the first insulation layer 30. In other words, the optical waveguide layer 40 can be formed with a uniform thickness since wrinkles in the base substrate 20 supporting the optical waveguide layer 40 are prevented from forming during the manufacturing process. Then, after the optical waveguide layer 40 is stacked, the base substrate 20 can be readily separated from the carrier 10 since the base substrate 20 is severed from the part of the first insulation layer 30 that is coupled to the carrier 10.

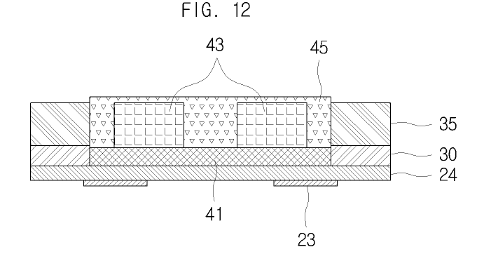

Meanwhile, as illustrated in FIG. 12, since the flexible copper clad laminate is used for the base substrate 20 in the present embodiment, a circuit pattern 23 can be formed by selectively etching the copper thin layer 22 of the flexible copper clad laminate after the step of severing the base substrate (S140).

According to an embodiment of the present invention, an optical waveguide layer having a uniform thickness can be formed by preventing wrinkles in a base substrate that supports the optical waveguide layer.

Furthermore, since a core substance and a clad substance are filled in a groove shaped area where a core unit and a clad layer are to be formed only, unnecessary waste of the core substance and the clad substance can be prevented.

While the spirit of the invention has been described in detail with reference to a certain embodiment, the embodiment is for illustrative purposes only and shall not limit the invention. It is to be appreciated that those skilled in the art can change or modify the embodiment without departing from the scope and spirit of the invention.

As such, many embodiments other than that set forth above can be found in the appended claims.

What is claimed is:

1. A method of manufacturing an optical waveguide, the method comprising:
providing a carrier;
fixing a base substrate to the carrier by using a first insulation layer such that the base substrate is directly stacked on the carrier;
stacking an optical waveguide layer on at least one of the base substrate and the first insulation layer; and
severing the base substrate such that the base substrate and the optical waveguide layer are separated from the carrier.

2. The method of claim 1, wherein the fixing of the base substrate comprises:
stacking the base substrate on the carrier; and
stacking the first insulation layer on the carrier such that the base substrate is fixed to the carrier.

3. The method of claim 1, wherein the fixing of the base substrate comprises:
adhering the first insulation layer to one surface of the base substrate; and
stacking the base substrate and the first insulation layer on the carrier in such a way that the other surface of the base substrate faces the carrier and then coupling the first insulation layer to the carrier.

4. The method of claim 2, wherein the stacking of the first insulation layer comprises stacking the first insulation layer on the carrier such that a wiring groove housing the optical waveguide layer is formed.

5. The method of claim 4, wherein the stacking of the first insulation comprises:
providing a first insulation layer having a first through-hole formed therein, the first through-hole corresponding to the wiring groove; and
stacking the first insulation layer on the carrier such that the first insulation layer covers a perimeter of the base substrate.

6. The method of claim 4, wherein the stacking of the first insulation layer comprises:
stacking a first insulation layer on the carrier, the first insulation layer covering the base substrate; and
forming the wiring groove by selectively removing the first insulation layer.

7. The method of claim 4, wherein the stacking of the optical waveguide layer comprises:
forming a first clad layer by filling a first clad substance in the wiring groove;
stacking a second insulation layer having a second through-hole formed therein on the base substrate or the first insulation layer, the second through-hole corresponding to the wiring groove;
forming a core unit on the first clad layer; and
forming a second clad layer by filling a second clad substance in the second through-hole, the second clad layer covering the core unit.

8. The method of claim 7, wherein the forming of the first clad layer comprises:
filling a first clad substance in the wiring groove;
flattening the filled first clad substance; and
hardening the filled first clad substance.

9. The method of claim 7, wherein the forming of the core unit comprises:
filling a core substance in the second through-hole;
flattening the filled core substance; and
hardening the filled core substance.

10. The method of claim 9, wherein the forming of the core unit further comprises patterning the hardened core substance by using a laser.

11. The method of claim 7, wherein the forming of the second clad layer comprises:
filling a second clad substance in the second through-hole; and
hardening the filled second clad substance.

12. The method of claim 1, wherein:
the base substrate comprises a flexible copper clad laminate (FCCL); and
in the fixing of the base substrate, the flexible copper clad laminate is stacked on the carrier in such a way that a copper thin layer faces the carrier.

13. The method of claim 12, further comprising, after the severing of the base substrate, forming a circuit pattern by selectively etching the copper thin layer of the flexible copper clad laminate.
